(19) United States
(12) Patent Application Publication
(10) Pub. No.: US 2013/0123980 A1
(43) Pub. Date: May 16, 2013

(54) METHOD AND SYSTEM FOR CONTROLLING MULTIPLE SMALL ROBOTS

(71) Applicant: Beom-Su SEO, Daejeon (KR)

(72) Inventor: Beom-Su SEO, Daejeon (KR)

(73) Assignee: Electronics and Telecommunications Research Institute, Daejeon (KR)

(21) Appl. No.: 13/596,149

(22) Filed: Aug. 28, 2012

(30) Foreign Application Priority Data
Nov. 14, 2011 (KR) 10-2011-0117968

(51) Int. Cl. G05B 19/418

(52) U.S. Cl. 700/248

(57) ABSTRACT

A method for controlling multiple small robots includes generating cooperation missions to be performed through cooperation with cooperation robots according to the manipulation of a main operator, generating an operator recruiting message including mission outline information for the cooperation missions, transmitting the operator recruiting message to neighboring robot mission units. The method further includes receiving participation information including robot situation information from at least one of the neighboring robot mission units, which participates in the cooperation, assigning divided missions to operators participating in the cooperation based on the robot situation information, and transmitting the assigned divided missions to the at least one of the neighboring robot mission units participating in the cooperation.

### CROSS-REFERENCE TO RELATED APPLICATION(S)

The present invention claims priority of Korean Patent Application No. 10-2011-0117968, filed on Nov. 14, 2011, which is incorporated herein by reference.

### FIELD OF THE INVENTION

The present invention relates to a technology of remotely controlling multiple small robots in a short distance under a multi-operator environment, and more particularly to a system and method for, in a condition that individual operators are operating respective small robots for surveillance and reconnaissance, dividing missions and accomplishing the divided missions through the cooperation between the individual operators, monitoring states of the small robots, and effectively controlling the small robots that are being individually controlled in a short distance.

### BACKGROUND OF THE INVENTION

As it is well known, robots, which are being used by secure facilities or social safety facilities, include substantially large platforms having weight greater than about 1 ton and small robots less than dozens of kilograms. Those robots are performing surveillance and reconnaissance missions in a specific area using a wireless local area network (LAN). A large scaled platform includes many different sensors and mission equipments mounted thereon and traverses by estimating its position through autonomous navigation using a high performance computer.

However, such a large scaled platform has a lot of constraints in its commercialization since it is very expensive and has many technical restraints and trouble finding a market, despite its technical development.

On the other hand, a small robot platform is portable and its technology has been substantively developed, so that the small robot platform can be effectively used for performing surveillance and reconnaissance missions in hazardous areas. Accordingly, US armies are using the small robot platform in Afghanistan, Iraq, and so on. The small robot platform has been developed in various types and shapes. A wheel-based platform is being diversely developed from a platform having weight less than 20 kg to a smaller platform having weight less than 1˜2 kg and maneuvering as an operator throws.

Although such a small robot employs a low-priced sensor, since it has an advantage of autonomously judging a surrounding situation as an operator participates in performing missions in a short distance, it is effectively used for military purposes such as counter-terrorism, local war, and so on, compared to mid-sized/large-sized platforms that are relatively large and employ a lot of mission equipments. That is, although its autonomic technology has been considerably developed, since the technology of the autonomous driving and gumption thereof cannot surpass human's cognitive ability, the mid-sized/large-sized robot is very limitedly used in areas where the robot easily traverses or in a case where a full-scale war is required. Therefore, a practical alternative to the above drawbacks is to fulfill a variety of missions including surveillance, alert, reconnaissance, and so on, through the use of the small robot.

Since a basic operating environment of the small robot depends on a one-to-one control scheme that one operator is assigned to one robot, monitors images provided from the robot in a short distance, and controls the robot using the monitored results, multiple robots committed into one mission area do not share information on their mission progressing states. Accordingly, one operator works faithfully on missions assigned thereto, but it cannot utilize a progressing status of whole missions or a state of each robot in performing its missions.

In addition, in case of changing some missions or adding new missions during performing missions, there is no systematic method to substitute or cancel existing missions by considering the continuity of the existing missions or the overlapping of mission areas. Therefore, when considering a situation of using the small robot in an actual battlefield, a new scheme, which is capable of improving mission capability of the robot through information sharing between individual robots and the cooperation between operators operating the individual robots, needs to be introduced, but there is no suggestion or proposal on the new scheme.

### SUMMARY OF THE INVENTION

It is, therefore, an object of the present invention to provide a method and system for generating missions, dividing the missions, assigning the divided missions, and collecting information, which is required in performing the assigned missions, through the cooperation between operators operating N numbers of small robots in a short distance, thereby effectively handling surroundings and accomplishing the assigned missions, wherein the collected information is secured from both of information gathered by a robot of a specific operator and information gathered by robots of other operators.

In accordance with an aspect of the present invention, there is provided a method for controlling multiple small robots, the method including generating cooperation missions to be performed through cooperation with cooperation robots according to the manipulation of a main operator, generating an operator recruiting message including mission outline information for the cooperation missions, and transmitting the operator recruiting message to neighboring robot mission units, receiving participation information including robot situation information from at least one of the neighboring robot mission units, which participates in the cooperation, assigning divided missions to operators participating in the cooperation based on the robot situation information, and transmitting the assigned divided missions to the at least one of the neighboring robot mission units participating in the cooperation.

In accordance with another aspect of the present invention, there is provided a system for controlling multiple small robots, the system including a control command generator configured to generate a remote control command for controlling a main robot controlled by a main operator or cooperation robots controlled by cooperation operators participating in the cooperation according to the manipulation of the main operator, and transmit the remote control command to the main robot or the cooperation robots through a network interface, a mission generator configured to generate cooperation missions according to the manipulation of the main operator, generate mission outline information for the cooperation missions, and, when participation information including robot situation information is received from at least one cooperation robot mission unit participating in the cooperation, assign divided missions to the cooperation operators according to the robot situation information, a cooperation unit configured to generate an operator recruiting message including the mission outline information, an information transmitter/receiver configured to transmit the operator recruiting message to neighboring robot mission units through the network interface, and transfer the participation information received from the at least one cooperation robot mission unit to the mission generator, a mission conducting unit configured to transmit the divided missions to the at least one cooperation robot mission unit, or receive and fulfill missions assigned thereto, and a video/audio transceiver configured to output robot state information of the cooperation robots controlled by the cooperation operators, which is received through the information transmitter/receiver, through the use of an video display and a speaker.

In accordance with embodiments of the present invention, by using a scheme of generating missions to be performed through the cooperation with neighboring robots, generating and transmitting an operator recruiting message including mission outline information for the generated missions to neighboring robot mission units, if participation information including robot situation information is received from at least one of the neighboring robot mission units, assigning divided missions to operators participating in the cooperation based on the robot situation information, and then transmitting the divided missions to robot mission units participating in the cooperation, it is possible to control the robots through the cooperation between operators in a short distance instead of individually controlling the robots. As a result, a semi-autonomous mission performing scheme that the operators participate in performing the missions and making a decision can be provided, so that it is possible to effectively fulfill missions of counter-terrorism, surveillance, reconnaissance, and so on, using small robots.

### BRIEF DESCRIPTION OF THE DRAWINGS

The above and other objects and features of the present invention will become apparent from the following description of embodiments given in conjunction with the accompanying drawings, in which:

FIG. 1 is a conceptual diagram illustrating an environment where individual operators operate a plurality of small robots in a short distance;

FIG. 2 illustrates a block diagram of a robot operating system, which is suitable for controlling a plurality of small robots through cooperation between operators, in accordance with an embodiment of the present invention;

FIGS. 3A and 3B are a flowchart illustrating processes of generating missions, assigning the missions, and performing the missions through the cooperation between operators in accordance with an embodiment of the present invention;

FIGS. 4A and 4B are a flowchart illustrating processes of securing information for states of robots that other operators are operating through the cooperation between multiple operators in accordance with an embodiment of the present invention; and

FIGS. 5A and 5B are a flowchart illustrating processes of controlling robots that other operators are controlling through the cooperation between multiple operators in accordance with an embodiment of the present invention.

### DETAILED DESCRIPTION OF THE EMBODIMENTS

Unlike the above-described conventional scheme that depends on a one-to-one control scheme of assigning one operator to one robot, monitoring images provided from the robot in a short distance, and controlling the robot using the monitored results, the present invention generates missions to be performed through the cooperation with neighboring robots, and generates and transmits an operator recruiting message including mission outline information for the generated missions to neighboring robot mission units. In addition, if participation information including robot situation information is received from at least one of the neighboring robot mission units, the present invention assigns divided missions to operators participating in the cooperation based on the robot situation information, and then transmits the divided missions to robot mission units participating in the cooperation. As a result, the present invention can effectively improve drawbacks of the conventional scheme. Herein, a robot mission unit, which is controlled by an operator and remotely controls a corresponding robot, can be referred to as, e.g., a small mission unit (SMU).

The mission outline information may include a summary of missions, mission area information, mission time information, mission details, and so on. The robot situation information may include location information of the operators participating in the cooperation, robot location information, mission progressing status (start, end, a current status, etc.) information, mission equipment status information, and so on.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Hereinafter, embodiments of the present invention will be described in detail with reference to the accompanying drawings so that they can be readily implemented by those skilled in the art.

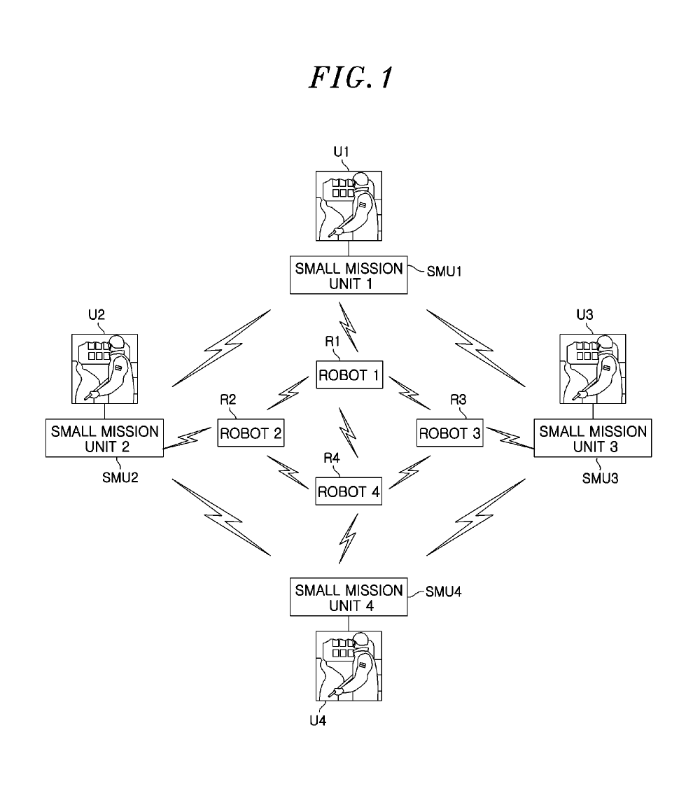

FIG. 1 is a conceptual diagram illustrating an environment where individual operators operate a plurality of small robots in a short distance.

Referring to FIG. 1, there are shown robots R1 to R4 controllable by individual operators (or individual robot operators) in a short distance and small mission units SMU1 to SMU4 respectively assigned to the robots R1 to R4. The small mission units SMU1 to SMU4 remotely control their corresponding robots R1 to R4 according to the control of respective operators U1 to U4.

When a certain operator, e.g., U1, fulfills missions in a specific area, the certain operator U1 provides neighboring operators U2 to U4 with mission outline information including, e.g., a summary of missions, mission area information, mission time information, mission details, and so on, asks them about whether they can participate in the missions, and divides the missions accordingly. Hereinafter, an operator who decided to participate in the missions is referred to as a “cooperation operator.” The divided missions are assigned to cooperation operators among the neighboring operators U2 to U4 s according to their locations, and then the cooperation operators perform the divided missions assigned thereto, e.g., surveillance and reconnaissance, in assigned areas using robots they are operating.

In addition, during missions, a specific operator, e.g., U1, who planned the missions or would like to know a progressing status of some missions may ask other robots R2 to R4, which other operators U2 to U4 are operating, to provide its corresponding small mission unit SMU1 with various information inputted only to the other operators U2 to U4, so that the specific operator U1 can secure information on the whole mission environment as well as information on mission areas where the specific operator U1 is performing the missions from sensor information of the other robots R2 to R4 (e.g., coordinate information of the other robots R2 to R4, obstacle information, dangerous situation information, etc.) or by watching images provided from the other robots R2 to R4, and checks a progressing status of the missions and where missions go using the secured information.

If necessary, the specific operator U1 can control the other robots R2 to R4 that the other operators U2 to U4 are operating through a grant from the other operators U2 to U4 in addition to a robot (or a small robot) R1 under its control using a remote control device it possesses. For this purpose, a small mission unit SMU may include at least one remote control device, a program capable of planning missions and assigning the missions, and a device and program for collecting information on operators and supporting the cooperation between the operators such as sharing of texts, voices, and images, etc. In addition, the small mission unit SMU may include a device for collecting video and sensor information of a robot, operating information of the robot, and so on, and a display for displaying the collected video and sensor information.

Accordingly, in accordance with the present invention, by fulfilling the cooperation between operators who control (operate) small robots in a short distance, it is possible to accomplish mission assignment, mission performance, robot information inquiry, and mission progressing situation monitoring.

Herein, a communication topology has a structure capable of executing communications between neighboring small mission units, e.g., SMU1 and SMU2, communications between a small mission unit, e.g., SMU1, and a robot, e.g., R1 controlled by the SMU1, and communications between a small mission unit, e.g., SMU1, and a robot, e.g., R2, controlled by another small mission unit, e.g., SMU2.

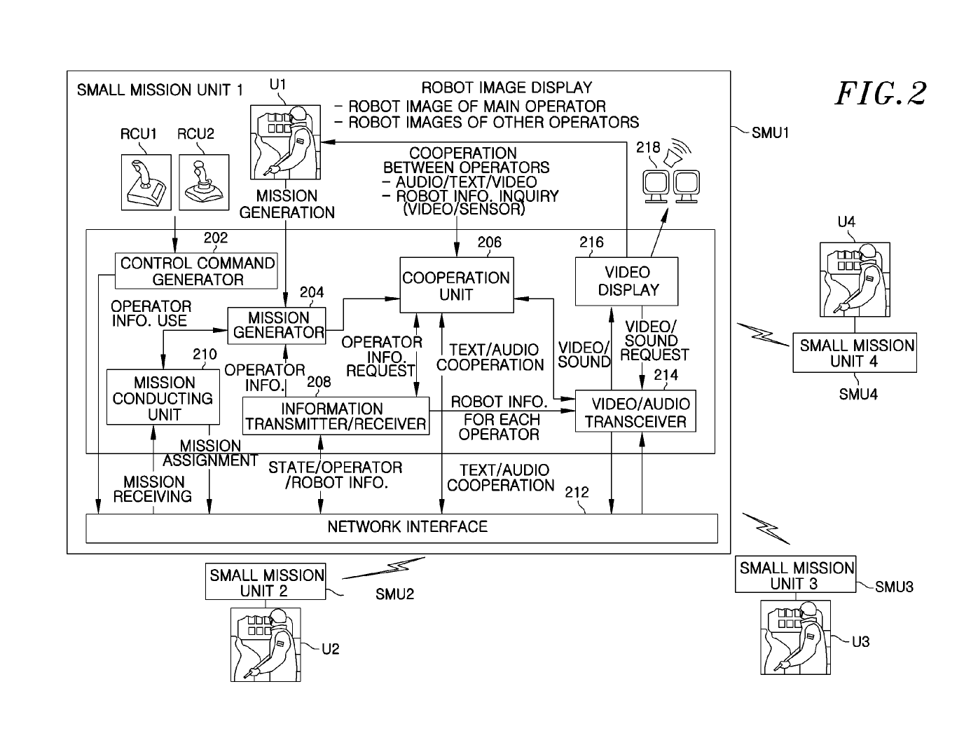

FIG. 2 is a block diagram of a robot operating system, which is suitable for controlling a plurality of small robots through the cooperation between plural operators, in accordance with an embodiment of the present invention.

Herein, the small robot employs low priced sensors and mission equipments and is controlled by an individual operator in a short distance. The small robot can be used in a situation inaccessible by an operator against explosion or an invisible dangerous situation. One operator is assigned to control only one robot using one small mission unit. For this purpose, the small mission unit employs a first remote control unit RCU1 for moving a robot assigned thereto in a short distance and a second remote control unit RCU2 for moving a camera, a manipulator, or other mission equipments the robot has.

Referring to FIG. 2, the robot operating system in accordance with an embodiment of the present invention includes a control command generator 202, a mission generator 204, a cooperation unit 206, an information transmitter/receiver 208, a mission conducting unit 210, a network interface 212, a video/audio transceiver 214, a video display 216, and a speaker 218.

When an operator U1 manipulates remote control units RCU1 and/or RCU2, the control command generator 202 generates remote control commands for remotely controlling a target robot in response to the manipulation of the operator u1. The remote control commands may be wirelessly transmitted to the target robot controlled by the operator U1 or another robot, e.g., one of robots R2 to R4 controlled by other operators U2 to U4, when the operator U1 receives permission from a corresponding one of the operators U2 to U4 to control one of robots R2 to R4, through the network interface 212.

The mission generator 204 generates missions suitable for the cooperation with neighboring robots in response to the manipulation of the operator U1 such as graphical user interface (GUI) manipulation, and generates mission outline information for the generated missions, which includes a summary of the missions, mission area information, mission time information, mission details, and so on. After that, the mission generator 204 transfers the mission outline information to the cooperation unit 206 to inquire about whether neighboring operators participate in the cooperation and to provide a function of requesting operator recruitment. Herein, a term of “mission” means a robot control performed by direct manipulation of an operator as well as self-moving to a certain area, surveillance, or reconnaissance performed by a robot itself.

The mission generator 204 also divides the generated missions and assigns the divided missions to operators participating in the cooperation (referred to as “cooperation operators”) in response to robot situation information when participation information, which includes the robot situation information (e.g., location information of the cooperation operators, robot location information, mission progressing state (start, end, a current state, etc.) information, mission equipment state information, and so on), is input from at least one neighboring robot mission unit participating in the cooperation (or at least one neighboring small mission unit participating in the cooperation) through the information transmitter/receiver 208. The mission generator 204 transmits the assigned missions to the mission conducting unit 210. Herein, the divided missions assigned to the cooperation operators and information about the cooperation operators may be displayed on a GUI window dedicated for the mission generation. The information about the cooperation operators may include personal information for each of the cooperation operators such as a name, a position, an operation starting time, and so on. Accordingly, the operator U1 verifies the information about the cooperation operators displayed on the GUI window, so that the operator U1 can recognize in real time which operator operates which robot around it. As a result, the operator U1 can assign proper missions to each of the cooperation operators.

For instance, the mission generator 204 assigns surveillance and reconnaissance missions to a robot having camera equipments and missions of removing mines or hazardous materials to a robot having a camera and an arm that is substitutable.

The cooperation unit 206 generates an operator recruiting message including the mission outline information transferred from the mission generator 204, and then transfers the operator recruiting message to the information transmitter/receiver 208 that in turn wirelessly transmits the operator recruiting message to neighboring other operators.

The cooperation unit 206 also requests the cooperation operators to permit sharing of information of other robots such as video information, audio information, and sensor information of the other robots according to the manipulation of the operator U1. For this purpose, an information sharing request message is generated and transferred to the video/audio transceiver 214. Herein, the sensor information of the other robots participating in the cooperation may include coordinate information of the other robots, obstacle information, dangerous situation information, etc. Each of the cooperation operators can perform the permission on the information sharing request from the operator U1 using a cooperation unit built in a robot mission unit thereof.

The cooperation unit 206 may also request the cooperation operators to permit the control of the other robots, i.e., request the cooperation operator to transfer the control authority for the other robots, according to the manipulation of the operator U1. A control request message generated for this purpose is transferred to the information transmitter/receiver 208. After that, if a control permission verification message is received through the information transmitter/receiver 208, the cooperation unit 206 may notify the operator U1 that the control permission verification message is received, using the video display 216. Each of the cooperation operators may perform the permission on the control request from the operator U1 using the cooperation unit built in the robot mission unit thereof.

The cooperation unit 206 may provide a text service, a voice communication service, and a video communication service between the cooperation operators U2 to U4 and the operator U1 during the mission cooperation.

Then, the information transmitter/receiver 208 wirelessly transmits various messages, e.g., the operator recruiting message and the control request message, which are transferred from the cooperation unit 206, to the neighboring other robots (or other robot mission units) through the network interface 212. In addition, the information transmitter/receiver 208 transmits the participation information including the robot situation information received from the cooperation operators (or the robot mission equipments participating in the cooperation) to the mission generator 204 and transmits robot information for each operator received from the neighboring other robots through the network interface 212 to the video/audio transceiver 214.

The mission conducting unit 210 transmits the divided missions for each operator (or mission assignment information) transferred from the mission generator 204 to neighboring robot mission units (neighboring small mission units) participating in the cooperation, i.e., cooperation robot mission units, through the network interface 212 and stores divided missions (mission assignment information) received from the cooperation robot mission units that the cooperation operators operate in an internal memory (not shown). After that, the mission conducting unit 210 instructs a robot under its control to perform missions assigned thereto.

For instance, the mission conducting unit 210 lets the cooperation operators U2 to U4 know information relating to missions such as where the robots R2 to R4 should move to, which missions the robots R2 to R4 should fulfill, until when the robots R2 to R4 should perform missions assigned thereto, which areas the robots R2 to R4 should surveil, what kind of sensor information the robots R2 to R4 should collect, and so on, thereby allowing each of the cooperation operators U2 to U4 to directly manipulate its corresponding robot.

In case of autonomous missions, the mission conducting unit 210 moves its corresponding robot to a specific area, monitors a certain direction for a given time using a dedicated mission equipment, and then transmits the monitored results to the operator U1 according to a request at the same time of transmitting the monitored results to each of the cooperation operators U2 to U4. In this case, the mission conducting unit 210 can be operated as being coupled to a control section and a driving section of the corresponding robot.

The video/audio transceiver 214 displays robot state information of the robot R1, which is transferred through the network interface 212, using the video display 216 and the speaker 218, displays information of the robots that the cooperation operators operate, which is transferred through the information transmitter/receiver 208, using the video display 216 and the speaker 218, or displays shared information (or robot state information) of the cooperation robot mission units, which is transferred through the network interface 212, using the video display 216 and the speaker 218. Herein, the robot state information of the other robots controlled by the cooperation operators may include video information, audio information, and sensor information, and the sensor information may include coordinate information of the other robots, obstacle information, and dangerous situation information. The video display 216 may include a display panel such as a liquid crystal display (LCD), a light-emitting diode (LED) display, and an organic LED (OLED) display.

Hereinafter, there will be described a sequence of processes of operating robots through the cooperation between operators in a multi-operator environment using the robot operating system in accordance with the present invention.

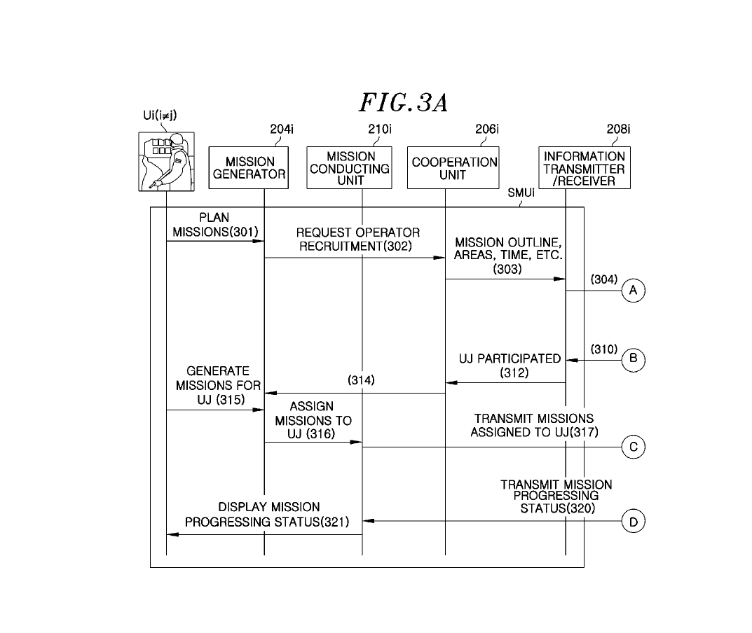

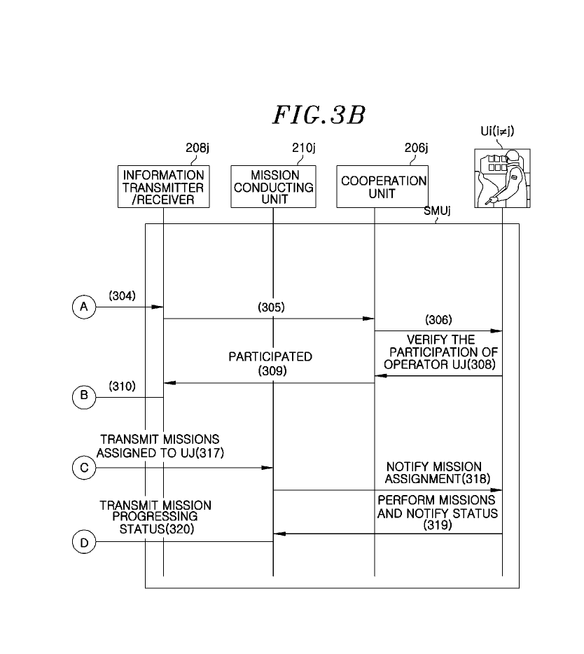

FIGS. 3A and 3B are a flowchart showing processes of generating missions, assigning the missions, and performing the missions through the cooperation between operators in accordance with an embodiment of the present invention.

Although neighboring multiple operators can cooperate with each other, assuming that two operator Ui and Uj cooperate with each other in accordance with an embodiment of the present invention for convenience of description and better understanding of the present invention.

Referring to FIGS. 3A and 3B, if the operator Ui plans missions for the cooperation using a GUI window dedicated for the mission generation in step 301, a mission generator 204i generates the missions to be cooperated with neighboring robots, generates mission outline information for the missions, which includes, e.g., a summary of the missions, mission area information, mission time information, and mission details, and then transfers the mission outline information to a cooperation unit 206i to inquire about whether neighboring operators participate in the cooperation and to request operator recruitment in step 302.

In response to the request for the operator recruitment, the cooperation unit 206i generates an operator recruiting message including the mission outline information received from the mission generator 204i and transfers the operator recruiting message to an information transmitter/receiver 208i in step 303. As a result, in step 304, the operator recruiting message is wirelessly transmitted to another robot mission unit (or small mission unit) SMUj operated by the neighboring operator Uj, which is coupled to the information transmitter/receiver 208i through a network, through a network interface (not shown, refer to “212” in FIG. 2).

After that, in the robot mission unit SMUj, an information transmitter/receiver 208j transfers the received operator recruiting message to a cooperation unit 206j in step 305. The cooperation unit 206j displays the operator recruiting message through a GUI window to allow the operator Uj to verify the message in step 306. As a result, the operator Uj can determine whether or not participating in the cooperation after examining the mission outline information included in the operator recruiting message. At this time, when the operator Uj has decided to participate in the cooperation, the operator Uj may be defined as a cooperation operator.

If the operator Uj decides to participate in the cooperation in step 308, the cooperation unit 206j generates participation information including robot situation information (e.g., location information of the operation Uj, robot location information, mission progressing status information, mission equipment status information, etc.), and transfers the participation information to the information transmitter/receiver 208j. After that, the information transmitter/receiver 208j wirelessly transmits the participation information to the robot mission unit SMUi through the network in step 310.

In response, the information transmitter/receiver 208i in the robot mission unit SMUi transfers the participation information, which includes the robot situation information of the operator Uj, to the cooperation unit 206i in step 312. The cooperation unit 206i transfers the participation information to the mission generator 204i, so that the robot situation information of the operator Uj is displayed through the GUI window dedicated for the mission generation.

Therefore, the operator Ui can assign divided missions to the operator Uj by referring to the displayed robot situation information of the operator Uj. If the operator Ui assigns the divided missions through the GUI window in step 315, the mission generator 204i generates the divided missions assigned to the operator Uj and transfers them to a mission conducting unit 210i in step 306.

Subsequently, the mission conducting unit 210i transmits the divided missions to the robot mission unit SMUj through the network interface in step 317.

In response, a mission conducting unit 210j in the robot mission unit SMUj notifies the operator Uj of the mission assignment by displaying the assigned missions through a GUI window in step 318. As a result, the operator Uj performs the assigned missions in step 319. A mission progressing status of the assigned missions is transmitted to the robot mission unit SMUi via the mission conducting unit 210j of the robot mission unit SMUj.

The mission progressing status information transmitted through the network interface of the robot mission unit SMUi is transferred to the mission conducting unit 210i in step 320. The mission conducting unit 210i displays the mission progressing status information through the GUI window in step 321. As a result, the operator Ui can monitor a progressing status of cooperation missions that are performed by the robot mission unit SMUj.

That is, in accordance with an embodiment of the present invention, as described above, it is possible to divide desired missions and perform the divided missions through direct communications between the robot mission unit SMUi and the robot mission unit SMUj, so that the operators Ui and Uj can monitor a status of the divided missions in progress.

In addition, although it is omitted in FIGS. 3A and 3B, in accordance with an embodiment of the present invention, it is possible to provide a text service, an audio service, and a videophone service between the robot mission units SMUi and SMUj using cooperation units thereof while the robot mission units SMUi and SMUj perform the cooperation missions, resulting in optimization of the mission cooperation.

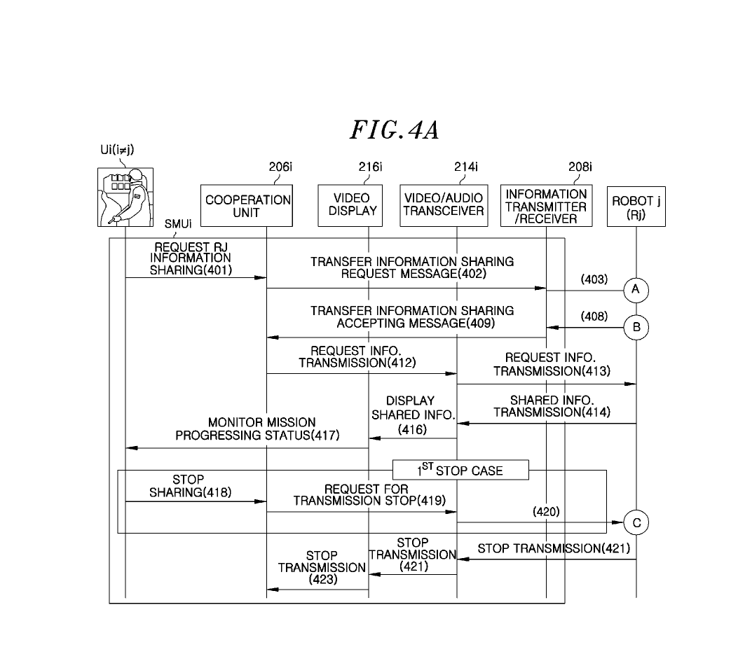

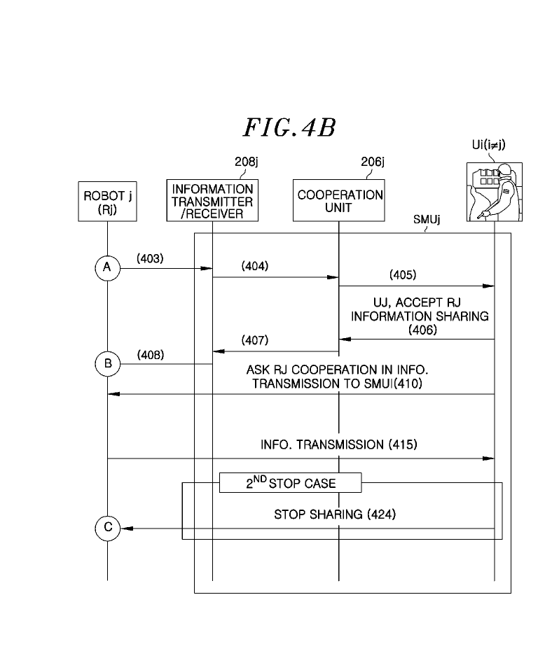

FIGS. 4A and 4B are a flowchart showing processes of securing information for states of robots that other operators are operating through the cooperation between multiple operators in accordance with an embodiment of the present invention. The operators can share information through these processes.

Referring to FIGS. 4A and 4B, if an operator Ui requests sharing of information for a robot Rj controlled by a robot mission unit SMUj participating in the cooperation through a GUI window in step 401, a cooperation unit 206i generates an information sharing request message and transfers it to an information transmitter/receiver 208i in step 402. After that, the information transmitter/receiver 208i wirelessly transmits the information sharing request message to a robot mission unit SMUj through a network interface (not shown, refer to “212” in FIG. 2) in step 403.

In response, in a robot mission unit SMUj, an information transmitter/receiver 208j transfers the information sharing request message received from the robot mission unit SMUi to a cooperation unit 206j in step 404. In step 405, the cooperation unit 206j displays the information sharing request message through a GUI window so that an operator Uj can verify the message. As a result, the operator Uj can determine whether to accept or reject the information sharing request after verifying the information sharing request message. At this time, the operator Uj can determine whether or not accept the information sharing request by considering the continuity of the existing missions the operator Uj is performing, mission areas, a status of mission equipments possessed by the robot Rj under its control, etc.

If the operator Uj accepts the information sharing request in step 406, the cooperation unit 206j generates an information sharing accepting message and wirelessly transmits it to the robot mission unit SMUi through the information transmitter/receiver 208j and a network interface (not shown) in steps 407 and 408. At this time, the cooperation unit 206j can ask the robot Rj to cooperate on transmitting information to the robot mission unit SMUi in step 410.

After that, the information transmitter/receiver 208i of the robot mission unit SMUi transfers the information sharing accepting message transmitted through the network interface to the cooperation unit 206i in step 409, so that the cooperation unit 206i generates a shared information transmission request message and transfers it to the video/audio transceiver 214i in step 412. Subsequently, the shared information transmission request message is wirelessly transmitted to the robot Rj through the network interface in step 413.

The robot Rj wirelessly transmits its robot state information to the robot mission unit SMUi in response to the shared information transmission request message in step 414. At the same time, the robot status information of the robot Rj is also transmitted to the cooperation unit 206j of the robot mission unit SMUj in step 415.

Herein, the robot state information provided to the robot mission unit SMUi may include video information, audio information, and sensor information of the robot Rj, and the sensor information may include coordinate information of the robot Rj, obstacle information, and dangerous situation information.

At this time, when an information transmission cooperation request message is transferred from the cooperation unit 206j of the robot mission unit SMUj and the shared information transmission request message is transferred from the robot mission unit SMUi, the robot Rj transmits its robot state information to the robot mission unit SMUi to prevent the unintended distribution of its robot state information.

After that, the video/audio transceiver 214i of the robot mission unit SMUi displays and outputs the robot state information of the robot mission unit SMUj, which is transmitted through the network interface, using a video display 216i and a speaker (not shown, refer to “218” in FIG. 2) in step 416, so that the operator Ui can monitor in real time a mission progressing status and a site situation of the robot mission unit SMUj by referring to the displayed information in step 417.

The information sharing between the robot mission unit SMUi and the robot mission unit SMUj may be stopped by the operator Ui or the operator Uj. If the operator Ui decides to stop the information sharing in step 418, the cooperation unit 206i generates a transmission stop request message accordingly and transfers it to the video/audio transceiver 214i in step 419. The transmission stop request message is wirelessly transmitted to the robot Rj through the network interface in step 420.

As a result, if the robot Rj generates a transmission stop verifying message and transmits it to the robot mission unit SMUi in step 421, the video/audio transceiver 214i receives the transmission stop verifying message and transfers it to the video display 216i and the cooperation unit 206i in steps 422 and 423, so that the display at the video display 216i is stopped, and the operator Ui recognizes that the information sharing for the robot Rj is stopped.

Meanwhile, if the operator Uj decides to stop the information sharing, the cooperation unit 206j of the robot mission unit SMUj generates a corresponding transmission stop message and transfers it to the robot Rj in step 424, so that the above steps 421, 422, and 423 are sequentially performed, and thus the robot mission unit SMUi stops the information sharing for the robot Rj.

That is to say, as described above, in accordance with an embodiment of the present invention, the operator Ui can secure the robot state information of the robot Rj as per the permission of the operator Uj, so that the operator Ui can monitor in real time a mission progressing status and a site situation of the robot Rj.

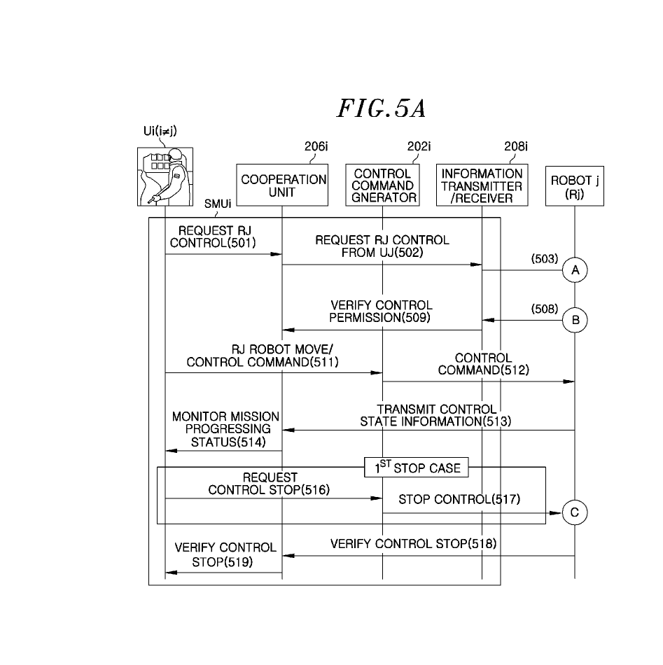

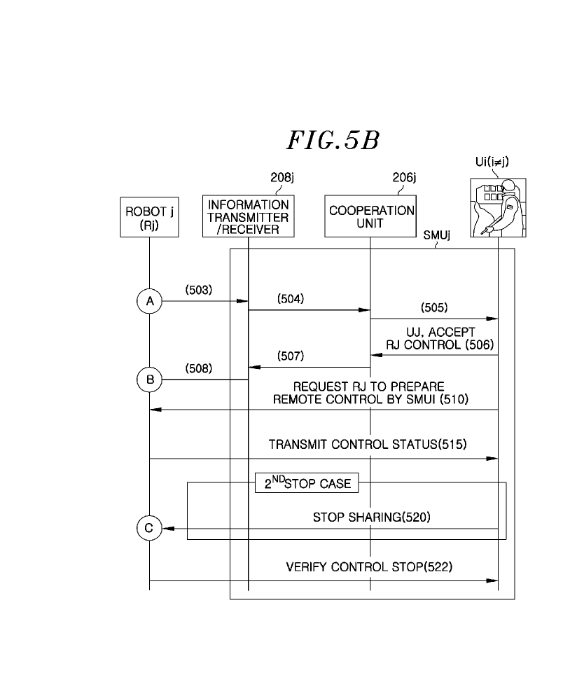

FIGS. 5A and 5B are a flowchart showing processes of controlling robots that other operators are controlling through the cooperation between multiple operators in accordance with an embodiment of the present invention.

Referring to FIGS. 5A and 5B, if an operator Ui requests the control of a robot Rj that is being controlled by a robot mission unit SMUj participating in the cooperation through a GUI window in step 501, a cooperation unit 206i generates a robot control request message accordingly and transfers it to an information transmitter/receiver 208i in step 502. As a result, the information transmitter/receiver 208i wirelessly transmits the robot control request message to the robot mission unit SMUj through a network interface (not shown, refer to “212” in FIG. 2) in step 503.

In response, in the robot mission unit SMUj, an information transmitter/receiver 208j transfers the robot control request message received from the robot mission unit SMUi to a cooperation unit 206j in step 504. The cooperation unit 206j displays the robot control request message through a GUI window, so that the operator Uj verifies the message in step 505. The operator Uj verifies the robot control request message and determines whether to accept or reject the robot control request for the robot Rj.

Herein, if the operator Uj accepts the robot control request in step 506, the cooperation unit 206j generates a robot control accepting message and wirelessly transmits it to the robot mission unit SMUi through the information transmitter/receiver 208j and a network interface (not shown) in steps 507 and 508. At this time, the cooperation unit 206j can request the robot Rj to prepare for the remote control by the robot mission unit SMUi in step 510.

Subsequently, in the robot mission unit SMUi, the information transmitter/receiver 208i transfers the robot control accepting message transmitted through the network interface to the cooperation unit 206i in step 509. The cooperation unit 206i displays the robot control accepting message through the GUI window so that the operator Ui recognizes that it can remotely control the robot Rj.

After that, if the operator Ui manipulates a remote control device (not shown) in step 511, the control command generator 202i generates a control command corresponding to the manipulation of the operator Ui and wirelessly transmits the control command to the robot Rj through the network interface in step 512.

Therefore, the robot Rj performs missions in response to the control command provided from the robot mission unit SMUi, and the missions performed accordingly is constructed as control state information, which is in turn transmitted to the cooperation unit 206i of the robot mission unit SMUi and the cooperation unit 206j of the robot mission unit SMUj at the same time or at different times in steps 513 and 515.

As a result, since the control state information is displayed through the video displays and the speakers of the robot mission units SMUi and SMUj in step 514, both of the operators Ui and Uj can simultaneously monitor a status of missions that the robot Rj is performing and a surrounding situation of the robot Rj.

Herein, since the operator Ui is a main agent that plans and manages the whole missions, and thus the operator Ui needs to clearly understand a progressing status of the whole missions and adjust the mission performance, the operator Ui is allowed to have an authority of controlling the robot Rj under the permission of the operator Uj, so that the operator Ui can appropriately fulfill the whole missions.

In the meantime, the remote control for the robot Rj by the robot mission unit SMUi may be stopped by the operator Ui or the operator Uj. If the operator Ui decides to stop the remote control in step 516, the control command generator 202i generates a control stop request message accordingly and transmits it to the robot Rj through the network interface in step 517.

As a result, the robot Rj generates a control stop verifying message and transmits it to the robot mission unit SMUi in step 518. The cooperation unit 206i receives the control stop verifying message and displays it, so that the operator Ui recognizes that the remote control for the robot Rj is stopped in step 519.

Meanwhile, if the operator Uj decides to stop the remote control, the cooperation unit 206j of the robot mission unit SMUj generates a control stop message accordingly and transmits it to the robot Rj in step 520. Then, the robot Rj generates a control stop verifying message accordingly and transmits it to the cooperation unit 206j of the robot mission unit SMUj in step 522. The cooperation unit 206j receives the control stop verifying message and displays it, so that the operator Uj recognizes that the remote control for the robot Rj by the operator Ui is stopped.

That is, as described above, in accordance with an embodiment of the present invention, the operator Ui can remotely control the robot Rj under the permission of the operator Uj, so that the operator Ui can appropriately fulfill the whole missions planned by itself.

Although, in accordance with the embodiment of the present invention, it is explained that the operator Ui remotely controls the robot Rj under the permission of the operator Uj, the present invention is not limited thereto. The operators Ui and Uj may be established to simultaneously control the robot Rj or the robot Rj may be configured to perform missions in response to a combination of control commands from the operators Ui and Uj.

While the invention has been shown and described with respect to the preferred embodiments, the present invention is not limited thereto. It will be understood by those skilled in the art that various changes and modifications may be made without departing from the scope of the invention as defined in the following claims.

What is claimed is:

1. A method for controlling multiple small robots, the method comprising:
generating cooperation missions to be performed through cooperation with cooperation robots according to the manipulation of a main operator;
generating an operator recruiting message including mission outline information for the cooperation missions, and transmitting the operator recruiting message to neighboring robot mission units;
receiving participation information including robot situation information from at least one of the neighboring robot mission units, which participates in the cooperation;
assigning divided missions to operators participating in the cooperation based on the robot situation information; and
transmitting the assigned divided missions to the at least one of the neighboring robot mission units participating in the cooperation.

2. The method of claim 1, wherein the transmitting of the operator recruiting message comprises:
generating, by a mission generator, the mission outline information so as to perform an operator recruiting request to inquire about whether or not participating in the cooperation for fulfilling the cooperation missions;
generating, by a cooperation unit, the operator recruiting message including the mission outline information according to the operator recruit request; and
transmitting, by an information transmitter/receiver, the operator recruiting message to the neighboring robot mission units.

3. The method of claim 2, wherein the mission outline information comprises a summary of the cooperation missions, mission area information, mission time information, and mission details.

4. The method of claim 1, further comprising:
displaying the assigned divided missions using a graphical user interface (GUI) window dedicated for the mission generation when assigning the divided missions.

5. The method of claim 1, wherein the robot situation information comprises location information of the operators participating in the cooperation, robot location information, mission progressing status information, and mission equipment status information.

6. The method of claim 1, further comprising:
receiving mission progressing status information from the at least one of mission robot units participating in the cooperation, and displaying the mission progressing status information.

7. The method of claim 1, further comprising:
requesting information sharing from the mission robot units participating in the cooperation;
requesting the cooperation robots controlled by the robot mission units participating in the cooperation to transmit robot state information when the robot mission units participating in the cooperation accept the information sharing; and
displaying the robot state information received from the cooperation robots.

8. The method of claim 7, wherein the cooperation robots transmit the robot state information when receiving a request for transmission cooperation from the robot mission units participating in the cooperation.

9. The method of claim 8, wherein the robot state information comprises video information, audio information and sensor information of the cooperation robots.

10. The method of claim 9, wherein the sensor information comprises coordinate information of the cooperation robots, obstacle information, and dangerous situation information.

11. The method of claim 1, further comprising:
sending a robot control request to the mission robot units participating in the cooperation;
transmitting a control command to the cooperation robots if the mission robot units participating in the cooperation accept the robot control request; and
displaying control state information received from the cooperation robots.

12. The method of claim 11, wherein the control state information is simultaneously transmitted to the robot mission units participating in the cooperation.

13. A system for controlling multiple small robots, the system comprising:
a control command generator configured to generate a remote control command for controlling a main robot controlled by a main operator or cooperation robots controlled by cooperation operators participating in the cooperation according to the manipulation of the main operator, and transmit the remote control command to the main robot or the cooperation robots through a network interface;
a mission generator configured to generate cooperation missions according to the manipulation of the main operator, generate mission outline information for the cooperation missions, and, when participation information including robot situation information is received from at least one cooperation robot mission unit participating in the cooperation, assign divided missions to the cooperation operators according to the robot situation information;
a cooperation unit configured to generate an operator recruiting message including the mission outline information;
an information transmitter/receiver configured to transmit the operator recruiting message to neighboring robot mission units through the network interface, and transfer the participation information received from the at least one cooperation robot mission unit to the mission generator;
a mission conducting unit configured to transmit the divided missions to the at least one cooperation robot mission unit, or receive and fulfill missions assigned thereto; and
a video/audio transceiver configured to output robot state information of the cooperation robots controlled by the cooperation operators, which is received through the information transmitter/receiver, through the use of an video display and a speaker.

14. The system of claim 13, wherein the mission outline information comprises a summary of the cooperation missions, mission area information, mission time information, and mission details.

15. The system of claim 13, wherein the mission generator is configured to display the assigned divided missions through the use of a GUI window dedicated for the mission generation when the divided missions are assigned to the cooperation operators.

16. The system of claim 13, wherein the robot situation information comprises location information of the cooperation operators, robot location information, mission progressing status information, and mission equipment status information.

17. The system of claim 13, wherein the video/audio transceiver is configured to output the robot state information, which is received from the cooperation robots controlled by the at least one cooperation robot mission unit, using the video display and the speaker according to a request of the cooperation unit.

18. The system of claim 17, wherein the robot state information comprises video information, audio information and sensor information of the cooperation robots.

19. The system of claim 18, wherein the sensor information comprises coordinate information of the cooperation robots, obstacle information, and dangerous situation information.

20. The system of claim 13,
wherein the control command generator is configured to transmit the control command to the cooperation robots when the at least one cooperation robot mission unit permits robot control, according to a request of the cooperation unit, and
wherein the video/audio transceiver is configured to display control state information received from the cooperation robots using the video display.
